(19) United States
(12) Patent Application Publication
(10) Pub. No.: US 2007/0028516 A1
(43) Pub. Date: Feb. 8, 2007

(54) Methods of producing seeds

(75) Inventors: Robert James Ballensky, Meridian, ID (US); Donald Ray Turner, Othello, WA (US); Clayton Christopher Osburn, Meridian, ID (US)

Correspondence Address: SYNGENTA BIOTECHNOLOGY, INC.;PATENT DEPARTMENT, 3054 CORNWALLIS ROAD, P.O. BOX 12257, RESEARCH TRIANGLE PARK, NC, 27709-2257, US

(73) Assignee: Syngenta Participations AG

(21) Appl. No.: 11/499,049

(22) Filed: Aug. 4, 2006

Related U.S. Application Data
(60) Provisional application No. 60/705,853, filed on Aug. 5, 2005.

(51) Int. Cl. A01D 82/00; A01B 79/02

(52) U.S. Cl. 47/58.1 R; 56/1

(57) ABSTRACT

The present invention relates to novel methods of harvesting pods of legume plants, and to novel methods of producing seeds of such crops. The present invention also relates to methods of improving the quality of seeds, and to methods of drying seeds. The present invention further relates to seeds produced by such methods, and to bags of such seeds.

### FIELD OF THE INVENTION

The present invention relates to the field of agriculture, in particular to novel methods of producing seeds of legume plants, and to novel methods of harvesting pods of such crops. The present invention also relates to methods of improving the quality of seeds of legume plants.

### BACKGROUND OF THE INVENTION

Legumes or pulse vegetables are major vegetables crops belonging to the Leguminosae family (see e.g. Ib Libner Nonnecke, Vegetable Production, 1989, Van Nostrand Reinhold, NY Publisher, pp. 251-293). Phaseolus vulgaris L., the common or kidney bean, is one important member of the Leguminosae family. Around 2.5 to 3 millions tons of beans are produced yearly worldwide grown on a surface area of around 450,000 hectares. Common beans are grown to produce immature fleshy pods, which are consumed fresh or are canned or frozen (garden bean, also called snap bean), or dry mature seed (dry bean). Another important member of the Leguminosae family, is Pisum sativum L., also known as English or garden pea. The immature pea pod is usually shelled and the immature seeds are consumed, although some peas produce edible pods, which are consumed immature (e.g. snow peas or snap peas).

During the harvest process of immature pods of legumes for consumption, the immature pods are typically separated from the vines, while the rest of the plants remain unharvested in the fields. This is usually done using mechanical harvesters developed to this effect. By contrast, for seeds production, the pods are kept longer on the plant to allow the seeds to reach an appropriate physiological stage. In current methods of seeds production the plants are typically cut and windrowed onto the ground for natural drying. The windrows are generally 2-3 feet wide and can be 12-16 inches deep. After 3 to 5 days on the ground, the windrows are threshed and the seeds collected. However, the drying in the field is not uniform and results in variable plant and seed moisture. This often correlates with difficult harvesting and threshing conditions that cause physical damage to the seeds.

The seed coat is sensitive to rough treatment and damage, such as fine hairline cracks, which can jeopardize the potential seeds germination and cause poor or faulty germination. The physical damage causes reductions in both physical seed quality, for example cracked seed coats, and physiological seed quality, for example germination. Special seed harvesters have been designed for seeds production to reduce the damage caused by threshing (see e.g. Ib Libner Nonnecke, Vegetable Production, 1989, Van Nostrand Reinhold, NY Publisher, p. 279), but there is still a substantial risk of damage to the seeds. Seeds production for some varieties, especially those with a very delicate seed coat, is difficult, sometimes even not economically possible.

In some production areas, mature pods are picked by hand for seeds production. However, this is very labor intensive and time consuming, and not cost-effective.

Consequently, there is an unmet need to reduce the damage caused to the seeds of legume plants during the current methods of seeds production, and to increase the quality of the seeds. There is also an unmet need for more uniformly dried seeds of legume plants.

### SUMMARY OF THE INVENTION

The invention addresses the above needs by providing novel methods for producing seeds of legumes crops and novel methods of harvesting pods of such crops. The invention also addresses the above needs by providing novel methods of improving the quality of seeds of such crops and novel methods for drying seeds of such crops. The invention also provides seeds obtained by the methods of the invention and bags of such seeds.

In one embodiment, a method for producing seed according to the invention comprises growing a legume plant in a field to produce a mature pod, mechanically stripping the mature pod from the plant growing in the field and obtaining a seed from the pod. In one embodiment, the method comprises drying the seed under controlled conditions to obtain a dried seed.

In another embodiment, the invention provides a method for harvesting a pod of a legume plant comprising growing a legume plant in a field to produce a pod, delaying the harvest of the pod until the pod is mature, and mechanically stripping the mature pod from the plant growing in the field. In one embodiment, the method comprises drying a seed of the pod mechanically stripped under controlled conditions to obtain a dried seed.

In one embodiment, a pod is stripped from a plant according to the invention when the seeds in the pod have particular moisture content. In one embodiment, the moisture content of such seeds is lower than the moisture content of the seeds in an immature pod when the immature pod is harvested for consumption. In one embodiment, the moisture content of such seeds is higher than the moisture content of a seed harvested according to the current method of seeds production.

In another embodiment, a pod is stripped from a plant according to the invention at a particular time point in the plant's growth. In one embodiment, such pod is stripped from the plant later than the average time of harvest for an immature pod for consumption. In one embodiment, such pod is stripped from the plant earlier than the usual time of harvest in current methods for seeds production.

In another embodiment, the invention provides a method for improving the quality of the seed of a legume plant comprising mechanically stripping a mature pod comprising a seed from a legume plant growing in a filed, drying the pod under controlled conditions, and obtaining a seed from said pod. In another embodiment, the invention further provides a method for drying the seed of a legume plant comprising obtaining a mature pod of a legume plant comprising a seed, drying said pod under controlled conditions, and obtaining a seed from said pod. In one embodiment the seed is dried until it comprises consistently between about 10% and about 15% moisture.

In one embodiment, the pod is mechanically harvested using a fresh produce harvester.

In one embodiment, the legume plant according to the invention is a bean plant or a pea plant. In one embodiment, the bean plant is a garden bean plant or a dry bean plant. In one embodiment, the pea plant is an edible-pod pea plant. In one embodiment, the edible-pod pea plant is a snow pea plant or a snap pea plant. In one embodiment, a legume plant of the invention is a plant producing a pod consumed immature, for example a garden bean plant or an edible-pod pea plant.

In another embodiment, at least about 90% of the seeds obtained by a method according to the invention pod are capable of germinating in a drop test, in one embodiment at least about 92%, in one embodiment at least about 94%. In one embodiment, the present invention further provides a bag of seeds produced by any one of the methods above.

Against the general belief in the art that plants bearing mature pods would not withstand the pulling force of a mechanical harvester and that entire plants or large portions of the plants would be pulled out and jam the harvester, the invention provides methods of producing seeds of legume plants using a mechanical fruit harvesters to strip mature pods from plants growing in a field. The methods of the invention reduce the damage to the seeds during harvest and result in improved seeds germination compared to current harvest and threshing techniques used in seeds production. The invention also allows for a more uniform drying of the seeds, which further improves seeds germination. This feature is particularly beneficial for varieties with low germination efficiencies. Moreover, the methods of the invention increase the harvest flexibility and reduce the influence of the weather in seeds production of legume crops. The invention also extends the window of use of mechanical fruit harvesters typically used to harvest immature pods during the year.

### DEFINITIONS

Controlled drying conditions: Means conditions, in which the main parameters for drying, such as temperature and relative humidity, are held within certain figures for the duration of the drying for a particular sample to be dried.
Immature pod: An immature pod is a pod, which predominantly comprises seeds not able to germinate when the pod is harvested and dried according to the invention.
Mature pod: A mature pod is a pod, which predominantly comprises seeds able to germinate when the pod is harvested and dried according to the invention.
Edible-pod pea plant: Pea plant capable of producing soft thick edible pods lacking the fibrous inner lining of the common pea. Examples of edible-pod peas are snow peas or sugar snap peas.
Snow pea: Type of the common pea (Pisum sativum var. macrocarpon) in the pea family, having a soft immature pod that lacks the fibrous inner lining of the common pea, and is typically thin and flat.
Sugar snap pea or snap pea: Type of pea plant producing peas having crisp rounded edible immature pods.
Growing days: Number of days as calculated from the date of sowing.
Plant Height: Plant height is taken from the top of soil to top most leaf of the plant and is measured in centimeters.
Heat tolerance: Heat tolerance is the ability to produce pods under conditions of 75 and over degrees F. during the night and 90 and over degrees F. during daytime.
Determinate Plant: A determinate plant will grow to a fixed number of nodes while an indeterminate plant continue to grow during the season.
Plant adaptability: A plant having good plant adaptability means a plant that will perform well in different growing conditions and seasons.
Plant architecture: Plant architecture is the shape of the overall plant, which can be for example tall-narrow or short-wide.
Plant habit: A plant can be erect (upright) to sprawling on the ground.
Pod set height: The pod set height is the location of the pods within the plant. The pods can be high (near the top), low (near the bottom), or medium (in the middle) of the plant, or scattered throughout the plant.
RHS: RHS refers to the Royal Horticultural Society of England which publishes an official botanical color chart quantitatively identifying colors according to a defined numbering system, The chart may be purchased from Royal Hort Society Enterprise Ltd RHS Garden;
Wisley, Woking; Surrey GU236QB, UK.
As used herein, the term “plant” includes plant cells, plant protoplasts, plant cells of tissue culture from which legume plants can be regenerated, plant calli, plant clumps, and plant cells that are intact in plants or parts of plants, such as pollen, flowers, seeds, pods, stalks, stumps, leaves and the like.

### DETAILED DESCRIPTION OF THE INVENTION

The invention addresses the needs to reduce the damage caused to the seeds of legume plants during the current harvesting and threshing methods of seeds production, and to increase the quality of the seeds. The invention also addresses the need for more uniformly dried legume seeds. The invention meets the above needs by providing novel methods of producing seeds of such crops, novel methods of harvesting pods of such crops, and novel methods of improving the quality of seeds of such crops and novel methods for drying seeds of such crops. The invention also provides seeds obtained by the methods of the invention, and bags of such seeds.

Immature pods for consumption, for example as fresh produce or for processing, are typically harvested approximately 2-3 weeks after full bloom for beans, or approximately 3 weeks after full bloom for peas. For bush bean plants, this corresponds to about 45 days to about 75 days from sowing, and for peas to about 65 days to about 80 days from sowing, depending on the variety and on the growing conditions. These figures also vary, if hot or cold spells occur. The pods in the immature state may be green or yellow, sometimes purple or reddish to purplish spotted or stripped. At the time of harvest for consumption, the immature pods are at approximately 60% moisture. Whether immature pods should be harvested for consumption may be determined by counting the number of days from the planting in the field or from full bloom. Other methods have also been developed. For example, the length of the center seed in an immature pod is measured, or the ratio of seed weight to pod weight is determined.

For seed production in legumes, the harvest occurs later in the season than for the production of immature pods for consumption, thus enabling the seeds to reach the desired physiological stage. However, as the plant further matures, a general desiccation of the plant also starts, which leads to a less vigorous and more brittle plant structure. The root system also deteriorates. Thus, against the general belief in the art that plants growing in a field and bearing mature pods would not withstand the pulling force of a mechanical harvester and that entire plants or large portions of the plants would be pulled and jam the harvester, the inventors of the invention have stripped mature pods from plants growing in the fields for seeds production using a mechanical fruit harvester typically used to harvest immature pods. Thus, in contrast to current methods for seeds production in legumes, in which plants are typically cut and windrowed onto the ground for natural drying, the methods of the invention include detaching pods from a plant growing in a field, while most of the rest of the plant is not pulled by the mechanical harvester and remains unharvested in the field. In the methods of the invention a short portion of the vine bearing the pod and a few leaves may also be detached from the plant and pulled by the mechanical fruit harvester when the pod is stripped from the plant growing in the field.

Thus, according to the present invention, mature pods are stripped from the plants growing in the field and further processed, which includes drying and threshing, instead of threshing entire plants as in current methods of seeds production. The utilization of a mechanical fruit harvester in place of traditional combines significantly reduces mechanical damage to threshed seeds. The pod protects the seed, and the process of pod picking reduces or even eliminates the physical or physiological damage to the seed. The methods of the invention thus reduce mechanical damage, which improves both physical and physiological quality of the seed.

In one embodiment, a method of the present invention comprises obtaining the seeds from a pod by threshing the pod. In one aspect, the pods are threshed within less than 2 months from the end of the drying of the pods, in another embodiment within less than 50 days from the end of the drying of the pods. In another embodiment, the pods are threshed 30 days to 45 days after the end of the drying of the pods.

In one embodiment, the pods are threshed using a bending belt thresher in a method of the present invention.

Table 1 in the Examples below shows increased germination efficiency in a Drop Test of seeds harvested using a method of the invention when compared to current harvesting and threshing techniques. The Drop Test evaluates the amount of damage that might occur during handling and processing of a seed.

In one embodiment of the invention, a pod is stripped from a plant growing in a field when the seeds in the pods have particular moisture content. In one embodiment, the moisture content of the seeds in the pod is lower than the moisture content of the seeds in an immature pod harvested for consumption. In another embodiment, the moisture content of the seeds in the pod is higher than the moisture content of the seeds in a pod harvested according to the current method of seeds production. In one embodiment, the moisture content of the seeds in a pod at the time of harvest according to the invention is less than about 40%, in another embodiment less than about 30%. In one embodiment, the moisture content of the seeds in a pod at the time of harvest according to the invention is more than about 16%, in another embodiment more than about 20%. In one embodiment, the moisture content of the seeds in a pod at the time of harvest according to the invention is about 16% to about 40%, in another embodiment 20% to about 40%, in another embodiment about 20% to about 30%, in another embodiment about 16% to about 25%, in another embodiment about 25%. The higher moisture content at the time of harvest according to the invention when compared to current methods for seeds production of legume plants allows for controlled and uniform drying of the seeds to the desired moisture content.

In another embodiment of the invention, a pod is stripped from a plant growing in a field at a particular time point in the plant's growth. In one embodiment of the invention, a pod is harvested later than the average time of harvest of an immature pod of the plant for consumption. In one embodiment, the pod is harvested about 10 days later than the average time of harvest of an immature pod of the plant for consumption. In one embodiment of the invention, the pod is harvested up to about 20 days later than the average time of harvest of an immature pod of the plant for consumption. In one embodiment of the invention, the pod is harvested about 10 days to about 20 days later than the average time of harvest of an immature pod of the plant for consumption. The person skilled in the art knows how to determine the average time of harvest for immature pods for consumption for a variety at a particular location. In one embodiment, the average harvest time for immature pods for consumption is determined by measuring the average length of the center seed of 10 immature pods. In one embodiment, the pod is harvested earlier than the usual time of harvest for current methods for seeds production for the plant. In one embodiment, the pod is harvest about 5 days or more earlier than the usual time of harvest for current methods for seeds production for the plant.

In one embodiment, the pod is mechanically harvested using a fresh produce harvester. In one embodiment, a pod picker is used, for example a Pixall pod picker or a Byron pod picker (see e.g. http://www.oxbocorp.com/seed.html). However, any mechanical harvester suitable for harvesting immature pods can be used in the invention. Typically, the harvester strips the pods from the plants using rotating metal fingers, and once pulled from the plant, a fan assembly blows the pods into a hopper. The pods are generally held in the hopper until capacity is reached, at which time the pods are dumped into a transport truck to be hauled into the dryers. The utilization of a mechanical fruit harvester for seed production allows the pods to be stripped from the plants and dried independently from the plant under controlled conditions to obtain a dried seed. This is in contrast to current methods for seeds production where natural drying is used, which is very much dependent on the weather conditions, such as rain and variable temperatures.

Accordingly, in another embodiment, the present invention provides a method for drying the seed of a legume plant comprising obtaining a mature pod of a legume plant comprising a seed, drying said pod under controlled conditions, and obtaining a seed from said pod. The methods of the invention provide more uniform dry down of the seeds and more consistent moisture of the dried seeds, which ensures that the seed can withstand mechanical handling with less or even without injury.

In one embodiment, after picking the pods are delivered to a drying facility where they are dried under controlled drying conditions. Drying is achieved for example by forced air, typically produced by natural gas burners. For example, the pods are placed in bulk into metal drying boxes, at 1,500 lbs of pods per box, and the boxes placed onto the dryers. In one embodiment, drying conditions include drying at 90 degrees F. at 20% relative humidity (RH), for example for 48 to 72 hours.

In one embodiment, the pods are dried until the desired moisture content of the seeds is reached. The pods are then threshed and the dried seeds are collected. In another embodiment, the seeds are extracted from the pod and then dried. In another embodiment, a combination of the two above is carried out, including drying the pods to the desired moisture content, threshing the pod to obtain the seeds, and further drying the seeds until the desired moisture content has been reached. In one embodiment, the moisture content of a dried seed according to the invention is above about 10%, in one embodiment about 10% to about 15%, in one embodiment about 12% to about 15%, in one embodiment at about 12%. In one embodiment, the moisture content of the seeds produced according to the invention is more consistent than in seeds produced in current methods of seeds production. In one embodiment, at least 90% of the seeds have the moisture contents described above. In one embodiment, the moisture content of a seed is measured as described in Example 3 below.

In one embodiment, the present invention further provides seeds produced by a method of the invention and bags of such seeds. The quality of a seed produced according to the invention, in particular its germination frequency, is improved when compared to current methods of seeds production. This is shown in the examples below. In one embodiment, at least about 90% of the seeds obtained from a pod according to the invention are capable of germinating in a Drop Test, in one embodiment, at least about 92%, in one embodiment, at least about 94%. A Drop Test is described in Example 2 below. In one embodiment, the germination efficiency of seeds obtained according to the invention is at least about 5% higher than that of seeds obtained using current method for seeds production, in particular conventional field threshing.

In one embodiment, at least about 95% of the seeds in bag of the invention are free from mechanical damage, in one embodiment at least about 97%. In one embodiment, mechanical damage on a seed is determined using a hairline crack test, such as described in Example 4 below.

Other measurements of seeds quality are for example carried out as described in the Handbooks of the Association of Official Seed Analysts (AOSA), PMB #411, 1763 Las Cruces, Suite A, NM 88001 USA.

In one embodiment, a legume plant of the invention is a bean plant. In one embodiment, a bean plant of the present invention is a garden bean plant (also called snap bean), which is grown to develop immature fleshy pods, picked for canning, freezing and fresh use. In one embodiment, a bean plant of the present invention is a dry bean plant, which are consumed as shelled dry seed. In one embodiment, a dry bean plant of the present invention is a kidney bean plant or a cranberry bean plant. In another embodiment, a legume plant of the invention is a pea plant. In one embodiment, a pea plant of the present invention is an edible-pod pea plant, in one embodiment a snow pea plant or a snap pea plant. In one embodiment, a legume plant of the invention is plant producing a pod consumed immature, for example a garden bean plant or an edible-pod pea plant.

Seeds production for beans, in particular garden beans, and edible-pod peas is especially difficult, partly because varieties with less fibrous inner linings have been selected. This feature is appealing to consumers, who generally prefer more refined pods with underdeveloped seeds. However, this leads to less protection to the seeds against physical damage. Also, varieties producing generally smaller and more tender seeds have been selected, further reducing their resistance to physical damage. Germination problems may occur and sometimes low germination frequencies are observed. The methods of the invention are therefore particularly beneficial for varieties with low germination efficiencies, and allow economical production of varieties, which may be difficult to produce using current methods of seeds production.

All references cited herein are incorporated by reference in the application in their entireties.

The following examples are intended to provide illustrations of the application of the present invention. The following examples are not intended to completely define or otherwise limit the scope of the invention.

### EXAMPLES

### Example 1

### Garden Bean Pod Picking Trial

Plants of three garden bean varieties were grown in fields in Nampa, Id. These varieties, Corella, BBL 156 and SB4363, are proprietary Syngenta varieties.

For each variety, pods were stripped from the plants using a Pixall pod picker, and delivered to a drying facility. The pods were transferred into metal drying boxes at 1,500 lbs of pods per box, and the boxes placed onto the dryers. The pods were dried at 90 degrees F. at 20% Relative Humidity for 48-72 hours. Drying was achieved by forced air produced by natural gas bumers. The pods were then threshed within 30-45 days and the seeds collected.

As a control, plants from the same variety planted on the same date and grown in the same field were cut and windrowed using a IH 1420 combine from International Harvesters, and allowed to dry in the field for 3 to 4 days. The windrows were then threshed by conventional filed threshing and the seeds collected.

Table 1 below indicates the planting and harvest dates for both harvesting methods.

Seeds were then tested for germination using a “Drop Test” and a “Wt 1 BM” test. The Drop Test is used to evaluate damage that might occur during handling and processing of the seeds, and is described below in Example 2. The “Wt 1 BM” refers to a Warm Towel 200 test and was performed before mill, i.e. before conditioning the seeds. The “Wt 1 BM” did not include the dropping of the seeds. For each sample, 200 seeds were tested and the percentages of germination are shown in Table 1 below.

Table 1 shows increased germination efficiency after the drop test for seeds harvested according to the invention when compared to seeds harvested using current methods of seeds production.

TABLE 1

| | Planting date | Harvest date | Acres | Threshing Means | Drop Test | Wt 1 BM |
|---|---|---|---|---|---|---|
| Corella | | | | | | |
| IH 1420 | May 14, 2004 | Sept. 1, 2004 | 1.05 | conventional field | 87 | 94 |
| combine | | | | threshing | | |
| Pixall pod | May 14, 2004 | Aug. 26, 2004 | 1.1 | corn sort belt feed, | 94 | 89 |
| picker | | | | stationary | | |
| BBL 156 | | | | | | |
| IH 1420 | Jun. 4, 2004 | Sept. 8, 2004 | 14.5 | conventional field | 89 | 92 |
| combine | | | | threshing | | |
| Pixall pod | Jun. 4, 2004 | Aug. 27, 2004 | 0.49 | Bending Belt | 97 | 97 |
| picker | | | | thresher | | |
| SB 4363 | | | | | | |
| IH 1420 | Jun. 2, 2004 | Sept. 9, 2004 | 14.6 | conventional field | 82 | 96 |
| combine | | | | threshing | | |
| Pixall pod | Jun. 2, 2004 | Aug. 27, 2004 | 0.4 | Bending Belt | 95 | 96 |
| picker | | | | thresher | | |

### Example 2

### Drop Test

The Drop Test is used to evaluate damage that might occur during the handling and processing of a seed. Seeds are dropped from a height of 34-36 inches under a controlled condition.

Seed is sampled from lot. The sample is then divided to give a true random sample using AOSA dividing procedures. Sample is then poured into the top of the chamber where it drops and is then collected and dropped a second time.

Dropped seeds are then tested in a standard Warm Towel 200 seed test using AOSA rules for evaluation, and the remained of the seed that was divided but not dropped is sent in for parallel testing used as a benchmark to evaluate the damage caused by the drop.

### Example 3

### Measurement of the Moisture Content of a Seed Sample

The moisture content of a seed sample is determined by using a Sinar Grain Pro 6310 Moisture Analyzer according to the manufacturer's instructions.

### Example 4

### Hairline Crack Test

Three cups of water, 1 fl oz food coloring (red or blue) and 1 teaspoon of dish soap are mixed. A sample of 100 bean seeds (not visibly broken) is prepared and placed in a dipping screen utensil. The seeds are dipped for 10 seconds into the dye mixture (more than 10 sec may cause wrinkled seed and inaccurate results). The seeds are removed from the solution and placed on paper towel.

Each seed is inspected by looking for cracks or broken seed coat. Cracks show dye brighter than dye on bean seed coat. Growth cracks or broken seed are not counted. The number of cracked seed is counted and gives the percent hairline crack.

### Example 5

### Garden Bean Pod Picking Trial

Plants of three garden bean varieties were grown in fields in Nampa, Id. These varieties, Dusky, Mention and Souston, are proprietary Syngenta varieties.

For each variety, pods were stripped from the plants using a Pixall pod picker, and delivered to a drying facility. The pods were transferred into metal drying boxes at 1,500 lbs of pods per box, and the boxes placed onto the dryers. The pods were dried at 90 degrees F. at 20% Relative Humidity for 48-72 hours. Drying was achieved by forced air produced by natural gas burners. The pods were then threshed using a bending belt thresher after approximately 8 months and the seeds collected.

As a control, plants from the same variety planted on the same date and grown in the same field were cut and windrowed using a IH 1640 combine from International Harvesters, and allowed to dry in the field for 3 to 4 days. The windrows were then threshed by conventional filed threshing and the seeds collected.

Table 2 below indicates the planting and harvest dates for both harvesting methods.

Seeds were then tested for germination using a “Drop Test” and a “Wt 1 BM” test. The Drop Test is used to evaluate damage that might occur during handling and processing of the seeds, and is described below in Example 2. The “Wt 1 BM” refers to a Warm Towel 400 test and was performed before mill, i.e. before conditioning the seeds. The “Wt 1 BM” did not include the dropping of the seeds. For each sample, 400 seeds were tested and the percentages of germination are shown in Table 2 below.

The moisture content of the seeds at harvest was determined as described in Example 3 using approximately 1-2 lbs of seeds.

TABLE 2

| | Planting | | | Threshing | | | Moisture |
|---|---|---|---|---|---|---|---|
| | date | Harvest date | Acres | Means | Drop Test | Wt 1 BM | content |
| Dusky | | | | | | | |
| IH 1640 | Jun. 7, 2005 | Oct. 14, 2005 | 7.98 | conventional | 90 | 90 | 13.4% |
| combine | | | | field | | | |
| | | | | threshing | | | |
| Pixall pod | Jun. 7, 2005 | Sept. 21, 2005 | 1.02 | bending belt | 83 | 88 | 17.5% |
| picker | | | | thresher | | | |
| Mention | | | | | | | |
| IH 1640 | Jun. 9, 2005 | Oct. 18, 2005 | 10.02 | conventional | 86 | 90 | 15.1% |
| combine | | | | field | | | |
| | | | | threshing | | | |
| Pixall pod | Jun. 9, 2005 | Oct. 2, 2005 | 0.98 | bending belt | 86 | 93 | 21.5% |
| picker | | | | thresher | | | |
| Souston | | | | | | | |
| IH 1640 | Jun. 9, 2005 | Oct. 19, 2005 | 11.98 | conventional | 92 | 96 | 15.5% |
| combine | | | | field | | | |
| | | | | threshing | | | |
| Pixall pod | Jun. 9, 2005 | Oct. 2, 2005 | 1.02 | bending belt | 75 | 83 | 22.2% |
| picker | | | | thresher | | | |

For several samples, Table 2 shows lower or comparable germination efficiency for seeds harvested according to the invention when compared to seeds harvested using current methods of seeds production. The pods harvested according to the invention were dried and stored for approximately 8 months before threshing. This appears to have caused the seed to begin to degrade, leading to reduced germination efficiency.

What is claimed is:

1. A method for producing seed of a legume plant comprising:
a) growing in a field a legume plant to produce a mature pod comprising a seed;
b) mechanically stripping said pod from said plant growing in the field; and
c) obtaining said seed from said pod.

2. The method of claim 1, wherein said method further comprises drying a seed of a pod mechanically stripped in step b) under controlled conditions to obtain a dried seed.

3. The method according to claim 1, wherein said pod is mechanically stripped using a fresh produce harvester.

4. A method for harvesting a pod of a legume plant comprising:
a) growing a legume plant in a field;
b) allowing said plant to produce a pod comprising a seed;
c) delaying the harvest of said pod until said pod is mature; and
d) mechanically stripping said mature pod from said plant growing in said field.

5. The method of claim 4, wherein said method further comprises drying a seed of a pod mechanically stripped in step d) under controlled conditions to obtain a dried seed.

6. The method according to claim 4, wherein said pod is mechanically stripped using a fresh produce harvester.

7. A method for improving the quality of the seed of a legume plant comprising:
a) mechanically stripping a mature pod comprising a seed from a legume plant growing in a field;
b) drying said pod under controlled conditions; and
c) obtaining a seed from said pod.

8. The method of claim 7, wherein said seed is dried until it comprises between about 10% and about 15% moisture.

9. A method for drying the seed of a legume plant comprising:
a) obtaining a mature pod of a legume plant comprising a seed;
b) drying said pod under controlled conditions; and
c) obtaining a seed from said pod.

10. The method of claim 9, wherein said seed is dried until it comprises about 10% to about 15% moisture.
